(19) United States
(12) Patent Application Publication
(10) Pub. No.: US 2025/0239592 A1
(43) Pub. Date: Jul. 24, 2025

(54) BATTERY CELL INCLUDING ANODE ELECTRODE WITH A STEPPED GRADIENT CONCENTRATION OF SI-BASED ANODE ACTIVE MATERIAL

(71) Applicant: GM GLOBAL TECHNOLOGY OPERATIONS LLC, Detroit, MI (US)

(72) Inventors: Dewen KONG, Shanghai (CN); Meiyuan WU, Shanghai (CN); Yan WU, Shanghai (CN); Haijing LIU, Shanghai (CN)

(21) Appl. No.: 18/596,814

(22) Filed: Mar. 6, 2024

(30) Foreign Application Priority Data
Jan. 20, 2024 (CN) 202410085022.6

(51) Int. Cl. H01M 4/36; H01M 4/02; H01M 4/04; H01M 4/38; H01M 4/583; H01M 4/62

(52) U.S. Cl. CPC H01M 4/366; H01M 4/0404; H01M 4/0471; H01M 4/386; H01M 4/583; H01M 4/622; H01M 4/625; H01M 2004/027

(57) ABSTRACT

A battery cell includes C cathode electrodes, S separators, and A anode electrodes each including an anode active material layer arranged on an anode current collector. The anode active material layer includes N sub-layers and at least two of the N sub-layers have a different ratio of a Si-based anode active material and graphite, where A, S, C and N are integers greater than one.

### CROSS-REFERENCE TO RELATED APPLICATIONS

This application claims the benefit of Chinese Patent Application No. 202410085022.6, filed on Jan. 20, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including anode electrodes with a stepped gradient concentration of silicon-based anode active material.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes, S separators, and A anode electrodes each including an anode active material layer arranged on an anode current collector. The anode active material layer includes N sub-layers and at least two of the N sub-layers have a different ratio of a Si-based anode active material and graphite, where A, S, C and N are integers greater than one.

In other features, the Si-based anode active material is selected from a group consisting of LSO, chemically lithiated SiOx, Si—C, Si, Si nanowire, and Si alloys. N concentrations of the Si-based anode active material in the N sub-layers, respectively, monotonically increase with a transverse distance from a plane including the anode current collector. N concentrations of the Si-based anode active material in the N sub-layers, respectively, monotonically decrease with a transverse distance from a plane including the anode current collector.

In other features, at least one of the N sub-layers is a Si-based anode active material-deficient layer with a capacity loading in a range from 1 to 4 mAh/cm². At least one of the N sub-layers is a Si-based anode active material-deficient layer with 0 wt. % to 50 wt. % of the Si-based anode active material and 50 wt. % to 100 wt. % of the graphite. At least one of the N sub-layers is a Si-based anode active material-deficient sub-layer with 5 wt. % to 20 wt. % of the Si-based anode active material and 80 wt. % to 95 wt. % of the graphite. At least one of the N sub-layers is a Si-based anode active material-rich sub-layer including 20 wt. % to 70 wt. % of the Si-based anode active material and 30 wt. % to 80 wt. % of the graphite. At least one of the N sub-layers is a Si-based anode active material-rich sub-layer including 20 wt. % to 50 wt. % of the Si-based anode active material and 50 wt. % to 80 wt. % of the graphite.

In other features, the anode active material layer further comprises a conductive additive and a binder. The conductive additive is selected from a group consisting of single walled carbon nanotubes (SWCNT), multi-walled carbon nanotubes (MWCNT), Super P, graphite, and graphite nanoplates. The binder is selected from a group consisting of polyvinylidene difluoride (PVDF), polytetrafluoroethylene (PTFE), CMS, styrene butadiene rubber (SBR), polyacrylic acid (PAA), PAA-PHEA, and combinations thereof.

A method for manufacturing an anode electrode for a battery cell includes using a first die, depositing a first slurry mixture onto an anode current collector to form a first layer. The first slurry mixture includes a first ratio of a Si-based anode active material and graphite, a binder, a conductive additive, and solvent. The method includes using one of the first die and a second die, depositing a second slurry mixture onto the anode current collector to form a second layer. The second slurry mixture includes a second ratio of the Si-based anode active material and graphite, the binder, the conductive additive, and the solvent and wherein the first ratio and the second ratio are different. The method includes drying the first layer and the second layer using an oven.

In other features, the Si-based anode active material is selected from a group consisting of LSO, chemically lithiated SiOx, Si—C, Si, Si nanowire, and Si alloys. The first layer has a lower concentration of the Si-based anode active material than the second layer.

In other features, at least one of the first layer and the second layer is a Si-based anode active material-deficient sub-layer with 5 wt. % to 20 wt. % of the Si-based anode active material and 80 wt. % to 95 wt. % of the graphite. At least one of the first layer and the second layer is a Si-based anode active material-rich sub-layer including 20 wt. % to 50 wt. % of the Si-based anode active material and 50 wt. % to 80 wt. % of the graphite.

A method for manufacturing an anode electrode for a battery cell includes creating a first mixture including a first ratio of a Si-based anode active material and graphite, a binder, and a conductive additive; mixing the first mixture to fibrillate the binder; forming a first free-standing layer using the first mixture; creating a second mixture including a second ratio of the Si-based anode active material and graphite, the binder, and the conductive additive, wherein the first ratio and the second ratio are different; mixing the second mixture to fibrillate the binder; forming a second free-standing layer using the second mixture; hot jointing the first free-standing layer to the second free-standing layer; and laminating the first free-standing layer and the second free-standing layer onto an anode current collector.

In other features, the Si-based anode active material is selected from a group consisting of LSO, chemically lithiated SiOx, Si—C, Si, Si nanowire, and Si alloys. The first free-standing layer has a lower concentration of the Si-based anode active material than the second free-standing layer. At least one of the first free-standing layer and the second free-standing layer is a Si-based anode active material-deficient sub-layer with 5 wt. % to 20 wt. % of the Si-based anode active material and 80 wt. % to 95 wt. % of the graphite. At least one of the first free-standing layer and the second free-standing layer is a Si-based anode active material-rich sub-layer including 20 wt. % to 50 wt. % of the Si-based anode active material and 50 wt. % to 80 wt. % of the graphite.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including A anode electrodes including a stepped gradient concentration of Si-based anode active material, C cathode electrodes, and S separators according to the present disclosure;

FIG. 2 is a side cross sectional view of an example of one of the A anode electrodes including an increasing stepped gradient concentration of Si-based anode active material according to the present disclosure;

FIG. 3 is a side cross sectional view of an example of one of the A anode electrodes including a decreasing stepped gradient concentration of Si-based anode active material according to the present disclosure;

FIG. 4 illustrates an example of a method for manufacturing the A anode electrodes including a stepped gradient concentration of Si-based anode active material according to the present disclosure;

FIG. 5 illustrates an example of a method for manufacturing the A anode electrodes including a stepped gradient concentration of Si-based anode active material according to the present disclosure;

FIG. 6 is a scanning electron microscope (SEM) image of an example of an active material layer of an anode electrode according to the present disclosure;

FIG. 7 is a graph illustrating voltage as a function of loading during a first cycle at a charging rate of C/20 and a temperature of 25° C. for anode electrodes including a homogenous anode active material layer and a stepped gradient anode active material layer according to the present disclosure; and

FIG. 8 is a graph illustrating voltage as a function of loading during a first cycle at a charging rate of C/5 and a temperature of 25° C. for anode electrodes including a homogenous anode active material layer and a stepped gradient anode active material layer according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Si-based anode active material such as lithiated silicon oxide (LSO) have a high first coulombic efficiency (>90%) and a large reversive specific capacity (−1400 mAh/g). Some anode electrodes may include an anode active material layer including a homogenous mixture of the Si-based anode active material and graphite instead of pure graphite. However, the Si material expands and contracts significantly during cycling.

The present disclosure relates to a battery cell including an anode electrode including anode active material layers with a plurality of sub-layers including stepped gradient concentrations of the Si-based anode active material to improve battery cell fast charging and/or cyclability. In other words, the anode active material layer includes N sub-layers each including different concentrations (e.g., increasing or decreasing concentrations) of Si-based anode active material, where N in an integer greater than one. In some examples, the concentration of the Si-based anode active material is homogenous within a given sub-layer and monotonically increases or decreases from one sub-layer to another.

In some examples, the stepped gradient concentration includes an increasing concentration of Si-based anode active material (e.g., LSO) in a transverse direction away from a plane including the anode current collector. For example, the anode active material includes an outer LSO-rich layer and an inner LSO-deficient layer arranged adjacent to the anode current collector. As compared to anode electrodes with a homogenous LSO concentration, the outmost LSO-rich layer conducts rapidly to deposit lithium ions (Li⁺) and releases volume expansion outwardly. The inner LSO-deficient layer (richer in graphite than the outer LSO-rich layer) provides a high conductivity path for electrons to facilitate fast-charging (e.g., at charging rates>3C). The lower concentrations of LSO in the inner LSO-deficient layer reduce expansion of the inner layer to reduce the risk of delamination of the anode active material layer due to volume expansion during DC fast charging (DCFC).

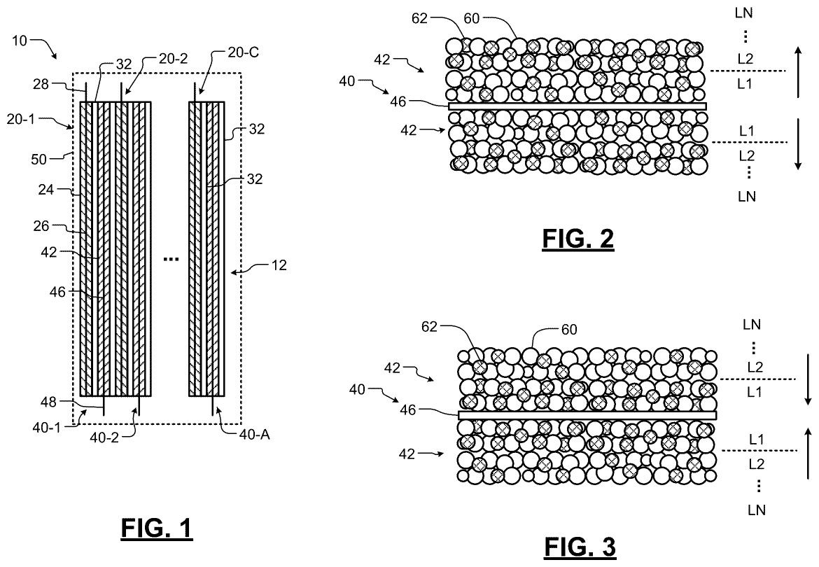

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include cathode active material layers 24 arranged on one or both sides of a cathode current collector 26.

The A anode electrodes 40-1, 40-2, . . . , and 40-A include anode active material layers 42 arranged on one or both sides of the anode current collectors 46. The anode active material layers 42 include sub-layers with a stepped gradient concentration of Si-based anode active material (e.g., LSO) in a direction transverse to a plane including the anode current collector. In some examples, the cathode active material layers 24 and/or the anode active material layers 42 comprise coatings including one or more active materials, one or more conductive additives, and/or one or more binder materials that are applied or cast onto the current collectors using a wet process or a dry process. The A anode electrodes 40 and the C cathode electrodes 20 exchange lithium ions during charging/discharging.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIGS. 2 and 3, an example of one of the A anode electrodes 40 is shown. In FIG. 2, the anode active material layer 42 includes N sub-layers each including different concentrations of Si-based anode active material 62, where N is an integer greater than one. For example, the concentration of Si-based anode active material 62 increases and the concentration of the graphite 60 decreases as the transverse distance between a respective one of the N sub-layers and a plane including the anode current collector 46 increases. In other words, a sub-layer L1 next to the anode current collector 46 has a lower concentration of Si-based anode active material 62 than a sub-layer L2. The sub-layer L1 has a higher concentration of graphite than the sub-layer L2. While N=2 in FIG. 2, N can be higher than 2.

In some examples, the sub-layer L2 comprises 40 wt. % Si-based anode active material and 60 wt. % of the graphite. The sub-layer L2 provides sufficient Li⁺ diffusion channels and the high operating potential Si-based anode active material conducts rapidly to efficiently deposit Li⁺ without Li plating. The gradient concentration of the sub-layer L2 improves fast charging capability.

The sub-layer L1 comprises 20 wt. % Si-based anode active material and 80 wt. % of the graphite. High electronic conductivity provides sufficient electrons during the fast charging and maintains rapid state of charge (SOC) balance between layers (e.g., between sub-layers L1 and L2). The sub-layer L1 has reduced volume expansion to preserve the robust adhesive force between the anode active material layer and the anode current collector to maintain cell cycling performance.

In FIG. 3, the anode active material layer 42 includes N sub-layers including different concentrations of Si-based anode active material 62 and graphite 60. In other words, Si-based anode active material concentration decreases and graphite concentration increases as the transverse distance between the respective one of the N sub-layers and the plane including the anode current collector 46 increases. In other words, the sub-layer L1 has a higher concentration of Si-based anode active material than the sub-layer L2 and the sub-layer L1 has a lower concentration of graphite than the sub-layer L2. In FIG. 3, N=2, although N can be higher than 2.

In some examples, the anode active material layer 42 includes Si-based active material, graphite, a binder, and a conductive additive. In some examples, the Si-based anode active material and graphite comprise 84 wt. % to 99 wt. % of the anode active material layer 42, the binder comprises 0.5 wt. % to 8 wt. % of the anode active material layer 42, and the conductive additive comprises 0.5 wt. % to 8 wt. % of the anode active material layer 42.

In some examples, the anode active material layer 42 comprises N sub-layers (e.g., on each side of the anode current collector 46), where N is an integer greater than one. One or more of the N layers have a different ratio of the Si-based anode active material and graphite. In some examples, the concentration of the Si-based anode active material in each of the N sublayers is in a range from 20 wt. % to 70 wt. %. In some examples, the capacity loading is in a range from 3 to 8 mAh/cm² (for a one-sided coating at 0.1C at room temperature). In some examples, the capacity loading is in a range from 4 to 6 mAh/cm² (for a one-sided coating at 0.1C at room temperature), In some examples, the press density is in a range from 1.6+/−0.5 g/cm³.

In some examples, the N sub-layers comprise a Si-based anode active material-rich layer and a Si-based anode active material-deficient layer. In some examples, the Si-based anode active material-rich layer includes 20 wt. % to 70 wt. % of the Si-based anode active material and 30 wt. % to 80 wt. % of the graphite. In other examples, the Si-based anode active material-rich layer includes 20 wt. % to 50 wt. % of the Si-based anode active material and 50 wt. % to 80 wt. % of the graphite.

In some examples, the capacity loading of the Si-based anode active material-rich layer is in a range from 1 to 4 mAh/cm² (for a one-sided coating at 0.1C at room temperature). In some examples, the capacity loading of the Si-based anode active material-rich layer is in a range from 2 to 4 mAh/cm² (for a one-sided coating at 0.1C at room temperature). In some examples, the porosity is in a range from 25% to 50%.

In some examples, the Si-based anode active material-deficient layer includes 0 wt. % to 50 wt. % of the Si-based anode active material and 50 wt. % to 100 wt. % of the graphite. In some examples, the Si-based anode active material-rich layer includes 5 wt. % to 20 wt. % of the Si-based anode active material and 80 wt. % to 95 wt. % of the graphite. In some examples, the capacity loading of the Si-based anode active material-deficient layer is in a range from 1 to 4 mAh/cm² (for a one-sided coating at 0.1C at room temperature). In some examples, the capacity loading of the Si-based anode active material-rich layer is in a range from 1 to 3 mAh/cm² (for a one-sided coating at 0.1C at room temperature). In some examples, the porosity is in a range from 25% to 50%.

In some examples, the Si-based anode active material is selected from a group consisting of LSO, chemically lithiated silicon oxide SiOₓ, Si—C, Si, Si nanowire, and Si alloys. In some examples, the Si-based anode active material comprises Li_{y}SiOₓ (0<x<2 and 0<y<1). In some examples, the D50 particle size is in a range from 3 μm to 20 μm. In some examples, Brunauer, Emmet and Teller surface area is in a range from 0.5 m²/g to 10 m²/g. In some examples, tap density (TD) is in a range from 0.8 g/cc to 1.5 g/cc. Morphology of the silicon-based materials can be nanoparticles, nanofibers, nanotubes, and microparticles.

In some examples, the graphite comprises particles having a D50 size in a range from 6 μm to 20 μm. In some examples, BET is in a range from 1 m²/g to 10 m²/g. In some examples, TD is in a range from 0.8 g/cc to 1.5 g/cc.

In some examples, the conductive additive comprises single walled carbon nanotubes (SWCNT), multi-walled carbon nanotubes (MWCNT), Super P, graphite, and graphite nanoplates. In some examples, the binder is selected from a group consisting of polyvinylidene difluoride (PVDF), polytetrafluoroethylene (PTFE), CMS, styrene butadiene rubber (SBR), polyacrylic acid (PAA), PAA-PHEA, and combinations thereof. In some examples, the PAA is neutralized by sodium hydroxide (NaOH) or lithium hydroxide (LiOH) (e.g., sodium polyacrylate (PAANa), PAAH_{0.2}N_{0.8} or lithium polyacrylic acid (LiPAA)).

In some examples, the anode electrodes are manufactured using a slurry coating process. In other examples, the anode electrodes are manufactured using a dry process including fibrillated PTFE as the binder.

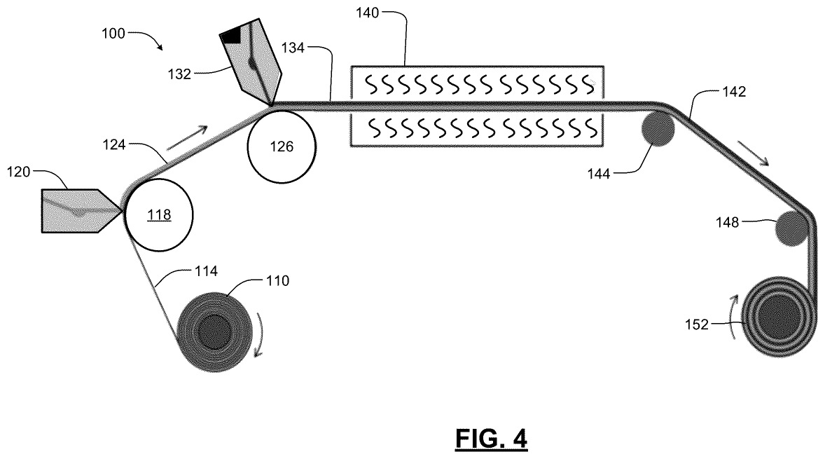

Referring now to FIG. 4A, an example of a slurry coating process is shown. A first slurry mixture for a first layer 124 or L1 of the anode active material layer (e.g., LSO and graphite with a first ratio, conductive additive, and binder) is mixed with solvent and supplied to a slotted die 120. An anode current collector 114 is supplied by a roll 110 around a roller 118 arranged adjacent to the slotted die 120. The slotted die 120 coats the first slurry onto the anode current collector 114 to form the first layer 124.

A second slurry mixture for a second layer 134 or L2 of the anode active material layer (e.g., LSO and graphite with a second blend, conductive additive, and binder) is mixed with solvent and supplied to a slotted die 132. The anode current collector 114 with the first layer 124 is supplied around a roller 126 arranged adjacent to the slotted die 132. The slotted die 132 coats the second slurry onto the anode current collector 114 to form the second layer 134.

The anode current collector 114 with the first layer 124 and the second layer 134 pass through an oven 140 to remove the solvent and dry the first layer 124 and the second layer 134. An anode electrode 142 passes over guide rollers 144 and 148 and is collected onto a roll 152.

In other examples, the first layer 124 can optionally be dried by another oven between the rollers 118 and 128. In other examples, a slotted die with two slots can be used to apply both the first layer 124 and the second layer 134 sequentially.

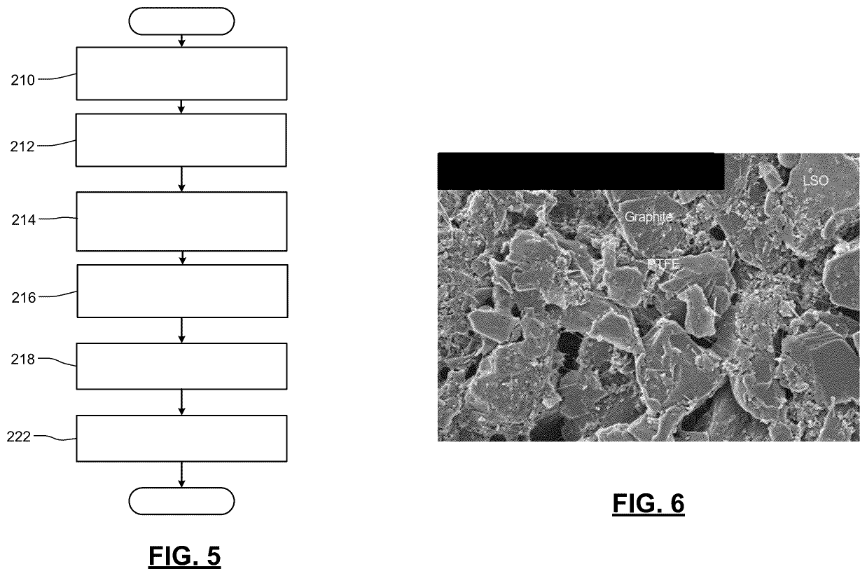

Referring now to FIG. 5, an example of a dry manufacturing process is shown. At 210, Si-based anode active material and graphite at first ratio are mixed with polytetrafluoroethylene (PTFE) binder and conductive additive and fibrillated. At 212, the first fibrillated mixture is pressed, calendared, and/or shaped to form a first free-standing film. At 214, Si-based anode active material and graphite are mixed at second ratio with polytetrafluoroethylene (PTFE) binder and conductive additive and fibrillated. At 216, the second fibrillated mixture is pressed, calendared, and/or shaped to form a second free-standing film. At 218, the first and second free-standing films are attached together using a hot joint (e.g., adhesive). At 222. The first and second films are laminated onto the anode current collector.

Referring now to FIGS. 6 to 8, an example of a battery cell including an anode electrode with an inner LSO-deficient layer and an outer LSO-rich layer is shown. The LSO-deficient layer includes 20 wt. % of the LSO and 80 wt. % of the graphite. The LSO-rich layer includes 40 wt. % of the LSO and 60 wt. % of the graphite. The binder includes PTFE. In FIG. 6, SEM images show the graphite, the LSO, and the fibrillated PTFE.

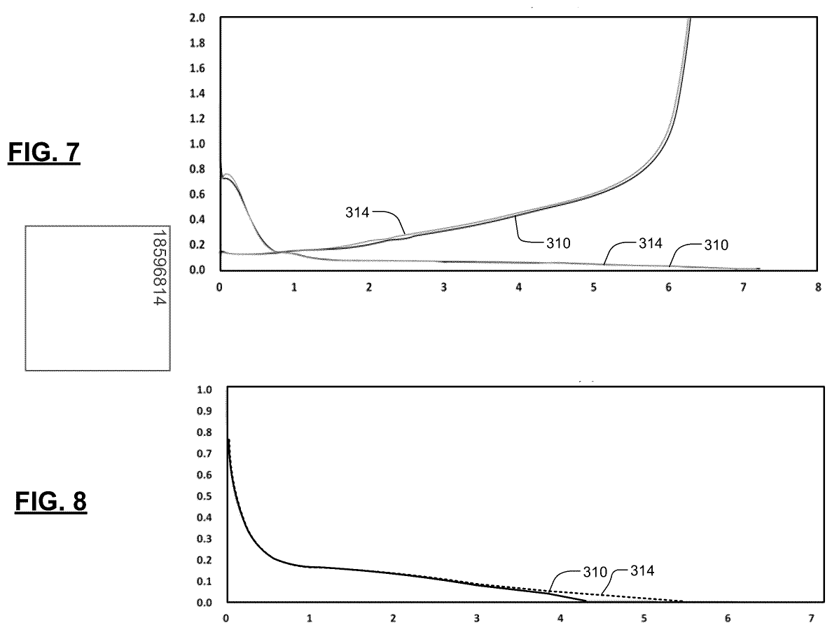

In FIG. 7, the stepped gradient anode electrode 314 is compared with a mono-layer anode electrode 310 with 30 wt. % of the LSO and 70 wt. % of the graphite. Lithiation is performed at C/20 continuous current and continuous voltage (CCCV) at 10 mV with a C/100 taper. Delithiation is performed at C/20 at 2V. The electrolyte includes 1M LiPF₆ in EC/EMC. The two electrodes deliver the same capacity and first columbic efficiency (CE) (e.g., ˜87%). In FIG. 8, the anode electrode with the stepped gradient LSO concentrations shows higher lithiation capacity than the mono-layer anode electrode 310.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
C cathode electrodes;
S separators; and
A anode electrodes each including an anode active material layer arranged on an anode current collector,
wherein the anode active material layer includes N sub-layers and at least two of the N sub-layers have a different ratio of a Si-based anode active material and graphite, where A, S, C and N are integers greater than one.

2. The battery cell of claim 1, wherein the Si-based anode active material is selected from a group consisting of LSO, chemically lithiated SiOₓ, Si—C, Si, Si nanowire, and Si alloys.

3. The battery cell of claim 1, wherein N concentrations of the Si-based anode active material in the N sub-layers, respectively, monotonically increase with a transverse distance from a plane including the anode current collector.

4. The battery cell of claim 1, wherein N concentrations of the Si-based anode active material in the N sub-layers, respectively, monotonically decrease with a transverse distance from a plane including the anode current collector.

5. The battery cell of claim 1, wherein at least one of the N sub-layers is a Si-based anode active material-deficient layer with a capacity loading in a range from 1 to 4 mAh/cm².

6. The battery cell of claim 1, wherein at least one of the N sub-layers is a Si-based anode active material-deficient layer with 0 wt. % to 50 wt. % of the Si-based anode active material and 50 wt. % to 100 wt. % of the graphite.

7. The battery cell of claim 1, wherein at least one of the N sub-layers is a Si-based anode active material-deficient sub-layer with 5 wt. % to 20 wt. % of the Si-based anode active material and 80 wt. % to 95 wt. % of the graphite.

8. The battery cell of claim 1, wherein at least one of the N sub-layers is a Si-based anode active material-rich sub-layer including 20 wt. % to 70 wt. % of the Si-based anode active material and 30 wt. % to 80 wt. % of the graphite.

9. The battery cell of claim 2, wherein at least one of the N sub-layers is a Si-based anode active material-rich sub-layer including 20 wt. % to 50 wt. % of the Si-based anode active material and 50 wt. % to 80 wt. % of the graphite.

10. The battery cell of claim 1, wherein:
the anode active material layer further comprises a conductive additive and a binder,
the conductive additive is selected from a group consisting of single walled carbon nanotubes (SWCNT), multi-walled carbon nanotubes (MWCNT), Super P, graphite, and graphite nanoplates; and
the binder is selected from a group consisting of polyvinylidene difluoride (PVDF), polytetrafluoroethylene (PTFE), CMS, styrene butadiene rubber (SBR), polyacrylic acid (PAA), PAA-PHEA, and combinations thereof.

11. A method for manufacturing an anode electrode for a battery cell comprising:
using a first die, depositing a first slurry mixture onto an anode current collector to form a first layer,
wherein the first slurry mixture includes a first ratio of a Si-based anode active material and graphite, a binder, a conductive additive, and solvent;
using one of the first die and a second die, depositing a second slurry mixture onto the anode current collector to form a second layer,
wherein the second slurry mixture includes a second ratio of the Si-based anode active material and graphite, the binder, the conductive additive, and the solvent and wherein the first ratio and the second ratio are different; and
drying the first layer and the second layer using an oven.

12. The method of claim 11, wherein the Si-based anode active material is selected from a group consisting of LSO, chemically lithiated SiOₓ, Si—C, Si, Si nanowire, and Si alloys.

13. The method of claim 11, wherein the first layer has a lower concentration of the Si-based anode active material than the second layer.

14. The method of claim 11, wherein at least one of the first layer and the second layer is a Si-based anode active material-deficient sub-layer with 5 wt. % to 20 wt. % of the Si-based anode active material and 80 wt. % to 95 wt. % of the graphite.

15. The method of claim 11, wherein at least one of the first layer and the second layer is a Si-based anode active material-rich sub-layer including 20 wt. % to 50 wt. % of the Si-based anode active material and 50 wt. % to 80 wt. % of the graphite.

16. A method for manufacturing an anode electrode for a battery cell comprising:
creating a first mixture including a first ratio of a Si-based anode active material and graphite, a binder, and a conductive additive;
mixing the first mixture to fibrillate the binder;
forming a first free-standing layer using the first mixture;
creating a second mixture including a second ratio of the Si-based anode active material and graphite, the binder, and the conductive additive, wherein the first ratio and the second ratio are different;
mixing the second mixture to fibrillate the binder;
forming a second free-standing layer using the second mixture;
hot jointing the first free-standing layer to the second free-standing layer; and
laminating the first free-standing layer and the second free-standing layer onto an anode current collector.

17. The method of claim 16, wherein the Si-based anode active material is selected from a group consisting of LSO, chemically lithiated SiOₓ, Si—C, Si, Si nanowire, and Si alloys.

18. The method of claim 16, wherein the first free-standing layer has a lower concentration of the Si-based anode active material than the second free-standing layer.

19. The method of claim 16, wherein at least one of the first free-standing layer and the second free-standing layer is a Si-based anode active material-deficient sub-layer with 5 wt. % to 20 wt. % of the Si-based anode active material and 80 wt. % to 95 wt. % of the graphite.

20. The method of claim 16, wherein at least one of the first free-standing layer and the second free-standing layer is a Si-based anode active material-rich sub-layer including 20 wt. % to 50 wt. % of the Si-based anode active material and 50 wt. % to 80 wt. % of the graphite.
